(19) United States
(12) Patent Application Publication
(10) Pub. No.: US 2019/0226548 A1
(43) Pub. Date: Jul. 25, 2019

(54) SHOCK ABSORBER

(71) Applicant: KYB Corporation, Tokyo (JP)

(72) Inventors: Masahiro MIWA, Gifu (JP); Hideaki TAKEUCHI, Gifu (JP)

(73) Assignee: KYB Corporation, Tokyo (JP)

(21) Appl. No.: 16/333,083

(22) PCT Filed: Sep. 11, 2017
(86) PCT No.: PCT/JP2017/032727

§ 371 Date: Mar. 13, 2019

(30) Foreign Application Priority Data
Sep. 23, 2016 (JP) 2016-185800

(51) Int. Cl. F16F 9/36; F16F 9/32

(52) U.S. Cl. CPC F16F 9/366; F16F 9/3235; F16F 9/369

(57) ABSTRACT

A shock absorber includes a cylinder tube, a damping-force generating portion, a rod, an annular guide portion, and an annular support portion provided to project from an inner circumferential surface of the cylinder tube, the support portion being configured to support the guide portion, wherein the guide portion has an opposing surface formed to oppose the inner circumferential surface of the cylinder tube, and a contacting surface in contact with the support portion, the contacting surface being inclined with respect to the opposing surface, and the contacting surface is formed so as to be, as a whole, inclined with respect to the opposing surface.

### TECHNICAL FIELD

The present invention relates to a shock absorber.

### BACKGROUND ART

Shock absorbers are mounted on vehicles, such as, for example, automobile, for suppressing vibration of a vehicle body by generating damping force. JP2015-218817A discloses a shock absorber that generates damping force by imparting resistance to a flow of working fluid.

The shock absorber disclosed in JP2015-218817A is provided with a piston that slides on an inner circumferential surface of a cylinder tube and a rod linked to the piston. The rod is inserted into an annular guide assembly that is provided on an opening portion of the cylinder tube. An outer circumferential surface of the guide assembly is formed with an annular hooking groove, and the hooking groove is supported by a snap ring that protrudes from the inner circumferential surface of the cylinder tube. An end portion of the cylinder tube is crimped radially inward so as to fix the guide assembly in the cylinder tube with the snap ring.

### SUMMARY OF INVENTION

With the shock absorber disclosed in JP2015-218817A, an outer circumferential edge of the hooking groove is formed with a right-angled corner portion. If a forming accuracy of the hooking groove is low, the corner portion may come to contact with the snap ring. In addition, depending on the size of an outer diameter of the guide assembly, the corner portion may come to contact with the snap ring. If the guide assembly is pushed against the snap ring while in a state in which the corner portion is in contact with the snap ring, there is a risk in that a high stress is produced in the hooking groove of the guide assembly.

If a high stress is produced in the hooking groove of the guide assembly, there is a risk in that the hooking groove is deformed and durability of the shock absorber is deteriorated. In order to improve the durability, a strict management of dimensional errors for the hooking groove is required, and so, it becomes difficult to produce the shock absorber.

An object of the present invention is to provide a shock absorber that is capable of improving durability and that is capable of being produced with ease.

According to one aspect of the present invention, a shock absorber includes a cylinder tube, a damping-force generating portion freely movably accommodated in the cylinder tube, the damping-force generating portion being configured to generate damping force by moving in the cylinder tube, a rod linked to the damping-force generating portion, the rod extending from an opening of the cylinder tube, an annular guide portion provided in an inner circumference of the cylinder tube, the guide portion being configured to guide movement of the rod, and an annular support portion provided to project from an inner circumferential surface of the cylinder tube, the support portion being configured to support the guide portion, wherein the guide portion has an opposing surface formed to oppose the inner circumferential surface of the cylinder tube, and a contacting surface in contact with the support portion, the contacting surface being inclined with respect to the opposing surface, and the contacting surface is formed so as to be, as a whole, inclined with respect to the opposing surface.

### BRIEF DESCRIPTION OF DRAWINGS

FIG. 1 is a sectional view of a shock absorber of a first embodiment according to the present invention,

FIG. 2 is an enlarged view of a portion A in FIG. 1,

FIG. 3 is an enlarged view of the portion A in FIG. 1 and shows a case in which a contacting surface is smaller than a desired size,

FIG. 4 is an enlarged view of the portion A in FIG. 1 and shows a case in which the contacting surface is larger than the desired size,

FIG. 5 is an enlarged view of the portion A in FIG. 1 and shows a case in which the contacting surface is formed to have a size different from the desired size,

FIG. 6 is an enlarged sectional view of the shock absorber of a comparative example,

FIG. 7 is an enlarged sectional view of the shock absorber of the comparative example and shows a case in which the contacting surface is smaller than the desired size,

FIG. 8 is an enlarged sectional view of the shock absorber of a modification of the first embodiment according to the present invention,

FIG. 9 is an enlarged sectional view of the shock absorber of another modification of the first embodiment according to the present invention,

FIG. 10 is an enlarged sectional view of the shock absorber of another modification of the first embodiment according to the present invention, and

FIG. 11 is an enlarged sectional view of the shock absorber of a second embodiment according to the present invention.

### DESCRIPTION OF EMBODIMENTS

A shock absorber 100 of an embodiment according to the present invention will be described below with reference to the drawings. Although description is given to the shock absorber 100 using working oil as working fluid in this description, it is possible to apply this embodiment to a shock absorber using other fluid such as working water, etc.

### First Embodiment

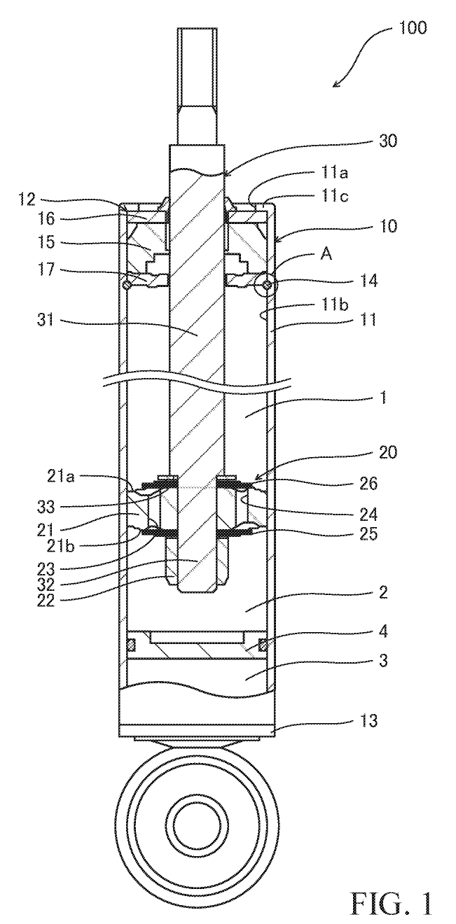

The shock absorber 100 of a first embodiment according to the present invention will be described first with reference to FIGS. 1 to 6. The shock absorber 100 is a device that suppresses vibration of a vehicle body by being provided, for example, between the vehicle body and an axle shaft of a vehicle (not shown) and generating damping force, and the shock absorber 100 may also called as “a single-cylinder-type shock absorber”.

As shown in FIG. 1, the shock absorber 100 is provided with a cylinder 10 that is filled with the working oil, a damping-force generating portion 20 that generates damping force by moving in the cylinder 10, and a rod 30 that is linked to the damping-force generating portion 20. The rod 30 is provided so as to be capable of moving with respect to the cylinder 10, and the rod 30 moves together with the damping-force generating portion 20 when the damping-force generating portion 20 generates damping force.

In the following, the direction along the rod 30 will be referred to as “the axial direction”, the radiating direction centered at the rod 30 will be referred to as “the radial direction”, and the direction along a circumference of the rod 30 will be referred to as “the circumferential direction”.

The cylinder 10 has a substantially cylindrical cylinder tube 11 that has openings on its both ends and an annular guide portion 12 that guides the movement of the rod 30. The rod 30 extends out from an opening 11a of the openings of the cylinder tube 11. The guide portion 12 is provided in an inner circumference of the cylinder tube 11. The other opening (not shown) of the openings of the cylinder tube 11 is closed by a cap portion 13.

The shock absorber 100 is further provided with an annular support ring (support portion) 14 that supports the guide portion 12. The support ring 14 projects from an inner circumferential surface 11b of the cylinder tube 11 so as to come to contact with the guide portion 12. The guide portion 12 is supported by being sandwiched between the support ring 14 and an end portion 11c of the cylinder tube 11 that is crimped radially inward.

The support ring 14 is a C-ring having a shape formed by cutting off a part of a perfect annular shape. An O-ring having a perfect annular shape may also be used as the support ring 14.

The guide portion 12 has a bearing member 15 that slidably supports the rod 30, a seal member 16 that closes the opening 11a of the cylinder tube 11, and a holding member 17 that holds the bearing member 15 and the seal member 16. An oil seal is provided between the bearing member 15 and the holding member 17. The bearing member 15 is formed to have an annular shape, and the rod 30 is inserted into a hole of the bearing member 15. The seal member 16 is provided with an inner circumference seal that provides sealing between the seal member 16 and the rod 30 and an outer circumference seal that provides sealing between the seal member 16 and the cylinder tube 11.

The seal member 16 is arranged between the opening 11a of the cylinder tube 11 and the bearing member 15 so as to close a gap between the bearing member 15 and the rod 30. The seal member 16 prevents foreign matters from flowing into the cylinder 10 through the opening 11a.

The rod 30 has a rod main body 31 that is supported by the bearing member 15 and a small-diameter portion 32 having the outer diameter smaller than the outer diameter of the rod main body 31. The small-diameter portion 32 is formed continuously from the rod main body 31, and a step portion 33 is formed between the small-diameter portion 32 and the rod main body 31.

The damping-force generating portion 20 is provided on an outer circumference of the small-diameter portion 32 of the rod 30. The configuration of the damping-force generating portion 20 will be described later in detail.

The damping-force generating portion 20 has a piston 21 that partitions the interior of the cylinder 10 into an extension-side chamber 1 and a compression-side chamber 2. The rod 30 extends out to the outside of the cylinder 10 from the piston 21 through the extension-side chamber 1. In the following, the rod 30 may also be referred to as “the piston rod 30”.

The piston 21 is formed to have an annular shape and is accommodated in the cylinder 10 in a freely slidable manner. The small-diameter portion 32 of the rod 30 is inserted into a hole of the piston 21, and the piston 21 is fixed to the rod 30 by a piston nut 22 that is screwed to a male screw (not shown) formed on an outer circumferential surface of the small-diameter portion 32.

As the rod 30 moves out from the cylinder 10, the shock absorber 100 is extended. At this time, the piston 21 moves together with the rod 30 in the direction in which the extension-side chamber 1 is compressed and the compression-side chamber 2 is expanded. As the rod 30 enters the cylinder 10, the shock absorber 100 is contracted. At this time, the piston 21 moves together with the rod 30 in the direction in which the compression-side chamber 2 is compressed and the extension-side chamber 1 is expanded.

The piston 21 is formed with an extension-side end surface 21a that faces the extension-side chamber 1, a compression-side end surface 21b that faces the compression-side chamber 2, a passage 23 that penetrates through the piston 21 between the extension-side end surface 21a and the compression-side end surface 21b, and a passage 24 that is provided separately from the passage 23 so as to penetrate through the piston 21 between the extension-side end surface 21a and the compression-side end surface 21b. The extension-side chamber 1 and the compression-side chamber 2 are communicated to each other through the passage 23 and the passage 24.

The damping-force generating portion 20 further has a damping valve 25 that is arranged on the compression-side end surface 21b of the piston 21 and a damping valve 26 that is arranged on the extension-side end surface 21a of the piston 21. The damping valve 25 is held by being sandwiched between the piston 21 and the piston nut 22, and the damping valve 26 is held by being sandwiched between the piston 21 and the step portion 33 of the rod 30.

The damping valve 25 is formed of a plurality of annular leaf valves that are layered on the compression-side end surface 21b of the piston 21. The damping valve 26 is formed of a plurality of annular leaf valves that are layered on the extension-side end surface 21a of the piston 21. Each of the damping valve 25 and the damping valve 26 may be formed of a single leaf valve.

The damping valve 25 opens and closes the passage 23 in accordance with the pressure difference between the extension-side chamber 1 and the compression-side chamber 2. More specifically, when the shock absorber 100 is extended and the pressure difference between the extension-side chamber 1 and the compression-side chamber 2 reaches the valve opening pressure of the damping valve 25, the damping valve 25 is opened, and a flow of the working oil in the passage 23 is allowed. At this time, the damping valve 25 imparts resistance to the flow of the working oil passing through the passage 23, and the pressure difference is produced between the extension-side chamber 1 and the compression-side chamber 2.

In a state in which the pressure difference between the extension-side chamber 1 and the compression-side chamber 2 has not reached the valve opening pressure of the damping valve 25, the damping valve 25 is kept closed, and the flow of the working oil in the passage 23 is shut off.

Similarly, when the shock absorber 100 is contracted and the pressure difference the compression-side chamber 2 and the extension-side chamber 1 reaches the valve opening pressure of the damping valve 26, the damping valve 26 is opened, and the flow of the working oil in the passage 24 is allowed. At this time, the damping valve 26 imparts resistance to the flow of the working oil passing through the passage 24, and the pressure difference is produced between the compression-side chamber 2 and the extension-side chamber 1.

In a state in which the pressure difference between the compression-side chamber 2 and the extension-side chamber 1 has not reached the valve opening pressure of the damping valve 26, the damping valve 26 is kept closed, and the flow of the working oil in the passage 24 is shut off.

As described above, the damping-force generating portion 20 produces the pressure difference between the extension-side chamber 1 and the compression-side chamber 2 by moving inside the cylinder tube 11 together with the rod 30 and generates damping force by thus produced pressure difference.

An air chamber 3 is formed in the cylinder 10, and gas is charged in the air chamber 3. The air chamber 3 is separated from the compression-side chamber 2 by a free piston 4 that is accommodated in the cylinder 10 in a freely slidable manner. As the free piston 4 moves, the air chamber 3 is expanded and contracted.

As the shock absorber 100 is contracted and the piston rod 30 enters inside the cylinder 10, the free piston 4 moves in the direction in which the air chamber 3 is compressed, and the air chamber 3 is compressed by an amount corresponding to the volume of the piston rod 30 that has entered. As the shock absorber 100 is extended and the piston rod 30 moves out from the cylinder 10, the free piston 4 moves in the direction in which the air chamber 3 is expanded, and the air chamber 3 is expanded by an amount corresponding to the volume of the piston rod 30 that has moved out.

As described above, the air chamber 3 compensates for volume change in the cylinder 10 caused by the operation of the shock absorber 100. The volume change in the cylinder 10 caused by the operation of the shock absorber 100 may be compensated for by a reservoir that is in communication with the cylinder 10.

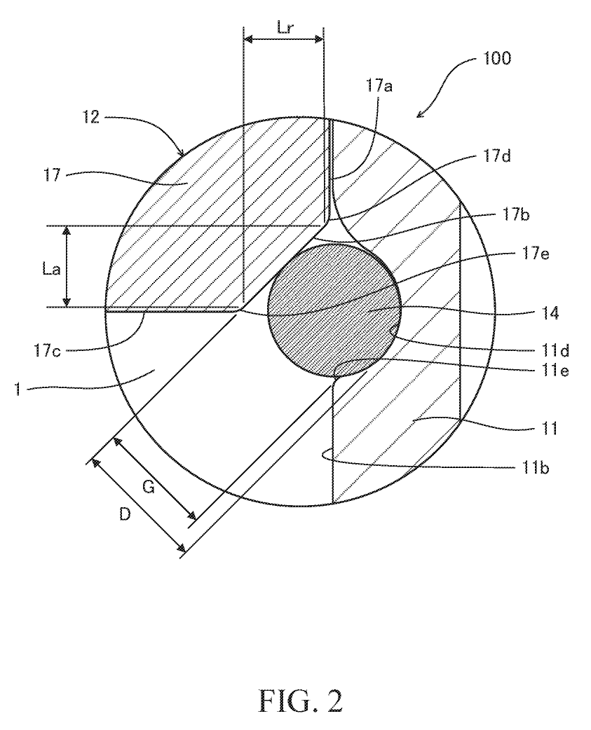

FIG. 2 is an enlarged view of a portion A in FIG. 1. As shown in FIG. 2, the support ring 14 is formed as a separate component from the cylinder tube 11. An annular groove 11d is formed in the inner circumferential surface 11b of the cylinder tube 11, and the support ring 14 is arranged in the groove 11d.

The holding member 17 is formed with an opposing surface 17a that opposes the inner circumferential surface 11b of the cylinder tube 11, a contacting surface 17b that is in contact with the support ring 14, and an end surface 17c that is substantially parallel to the radial direction and faces the extension-side chamber 1. The contacting surface 17b is inclined with respect to the opposing surface 17a and is inclined with respect to the end surface 17c.

A corner portion 17d is formed between the opposing surface 17a and the contacting surface 17b, and a corner portion 17e is formed between the end surface 17c and the contacting surface 17b. The corner portion 17d may have a sharp shape that is formed by the opposing surface 17a and the contacting surface 17b or the corner portion 17d may have a rounded shape. Similarly, The corner portion 17e may have a sharp shape that is formed by the end surface 17c and the contacting surface 17b or the corner portion 17e may have a rounded shape. Such a holding member 17 is formed by subjecting a circular plate member to a press working.

The contacting surface 17b is, as a whole, inclined with respect to the opposing surface 17a. In other words, the contacting surface 17b is not formed with a part that is parallel to the radial direction. Thus, the support ring 14 comes to contact with the contacting surface 17b at a position away from the corner portion 17d, and so, a predetermined gap is formed between the corner portion 17d and the support ring 14. Therefore, even in a case in which the forming accuracy of the contacting surface 17b is low and the contacting surface 17b is not formed to have a desired size, the corner portion 17d is less likely to come to contact with the support ring 14, and the contacting surface 17b comes to contact with the support ring 14. Even when the outer diameter of the holding member 17 is small, similarly to the case described above, the corner portion 17d is less likely to come to contact with the support ring 14, and the contacting surface 17b comes to contact with the support ring 14.

When the end portion 11c of the cylinder tube 11 is crimped, for example (see FIG. 1), or, when the guide portion 12 is pushed by a bump cushion (not shown) towards the cap portion 13 as the shock absorber 100 is contracted, the holding member 17 is pushed against the support ring 14. Because the contacting surface 17b comes to contact with the support ring 14 without bringing the corner portion 17d into contact with the support ring 14, even when the holding member 17 is pushed against the support ring 14, a high stress is not produced in the holding member 17. Therefore, it is possible to prevent deformation of the holding member 17 and to improve durability of the shock absorber 100. In addition, it is possible to reduce deterioration of a sealing property and noise caused by the deformation of the holding member 17.

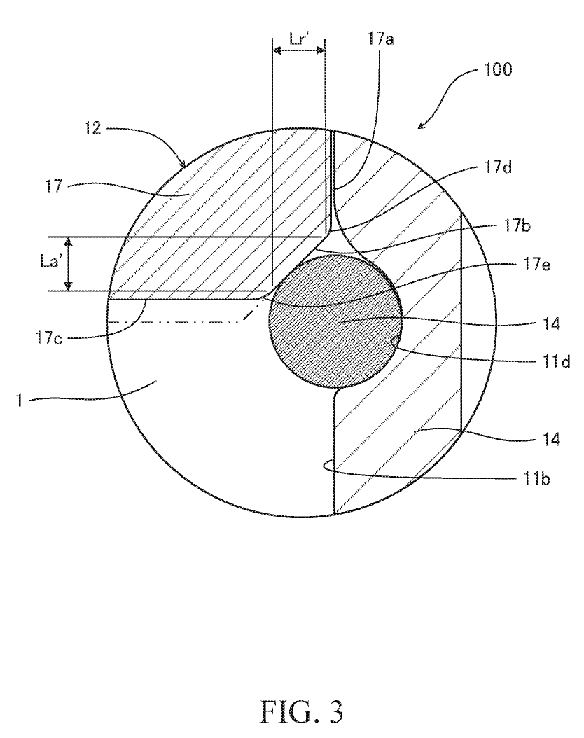

The contact between the contacting surface 17b and the support ring 14 will be described specifically with reference to FIGS. 3 to 5.

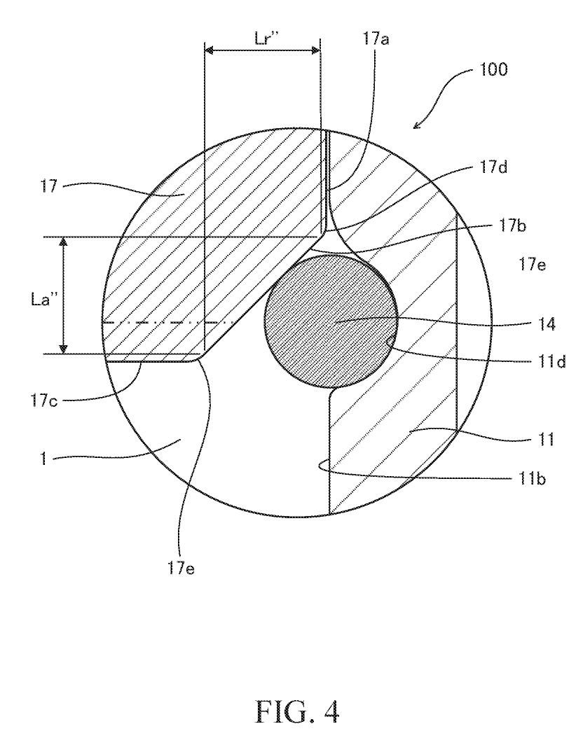

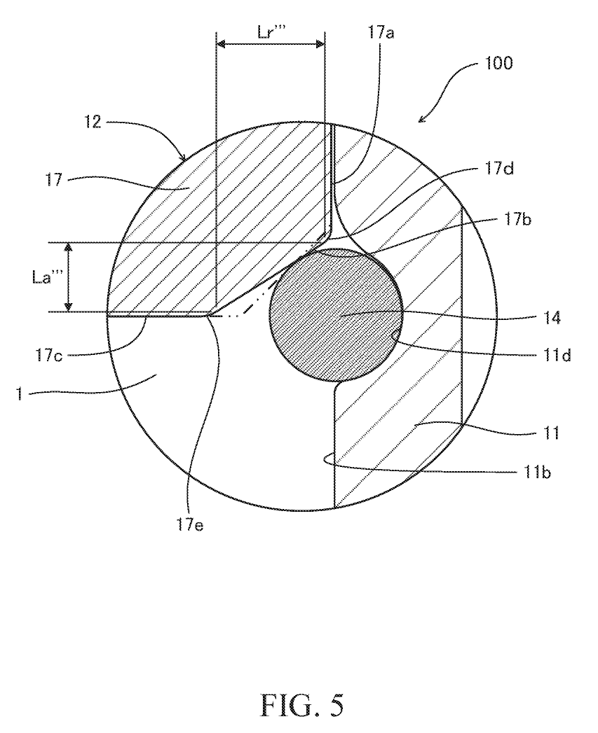

FIG. 3 is an enlarged view of the portion A in FIG. 1 and shows a case in which the contacting surface 17b is smaller than a desired size. FIG. 4 is an enlarged view of the portion A in FIG. 1 and shows a case in which the contacting surface 17b is larger than the desired size. FIG. 5 is an enlarged view of the portion A in FIG. 1 and shows a case in which the contacting surface 17b is formed to have a size different from the desired size. In FIGS. 3, 4, and 5, a shape and a position of the holding member 17 shown in FIG. 2 are shown by a two-dot chain line.

The contacting surface 17b shown in FIG. 3 is formed so as to be smaller than the contacting surface 17b shown in FIG. 2. More specifically, a longitudinal length (a dimension in the axial direction; the same applies in the following) La′ of the contacting surface 17b shown in FIG. 3 is shorter than the longitudinal length La of the contacting surface 17b shown in FIG. 2. In addition, a lateral length (a dimension in the radial direction; the same applies in the following) Lr′ of the contacting surface 17b shown in FIG. 3 is shorter than the lateral length Lr of the contacting surface 17b shown in FIG. 2.

As shown in FIG. 3, in a case in which the contacting surface 17b is smaller than the desired size, the position of the corner portion 17d is substantially the same as the position of the corner portion 17d shown in FIG. 2. In other words, the support ring 14 comes to contact with the contacting surface 17b at the position away from the corner portion 17d, and the corner portion 17d does not come to contact with the support ring 14.

The contacting surface 17b shown in FIG. 4 is formed so as to be larger than the contacting surface 17b shown in FIG. 2. More specifically, the longitudinal length La″ of the contacting surface 17b shown in FIG. 4 is longer than the longitudinal length La of the contacting surface 17b shown in FIG. 2. In addition, the lateral length Lr″ of the contacting surface 17b shown in FIG. 4 is longer than the lateral length Lr of the contacting surface 17b shown in FIG. 2.

As shown in FIG. 4, in a case in which the contacting surface 17b is larger than the desired size, the position of the corner portion 17d is substantially the same as the position of the corner portion 17d shown in FIG. 2. In other words, the support ring 14 comes to contact with the contacting surface 17b at the position away from the corner portion 17d, and the corner portion 17d does not come to contact with the support ring 14.

The contacting surface 17b shown in FIG. 5 is formed so as to be smaller in the axial direction and larger in the radial direction as compared with the contacting surface 17b shown in FIG. 2. More specifically, the longitudinal length La′″ of the contacting surface 17b shown in FIG. 5 is shorter than the longitudinal length La of the contacting surface 17b shown in FIG. 2. The lateral length Lr″″ of the contacting surface 17b shown in FIG. 5 is longer than the lateral length Lr of the contacting surface 17b shown in FIG. 2.

As shown in FIG. 5, in a case in which the contacting surface 17b is smaller in the axial direction and larger in the radial direction as compared with the desired size, although the corner portion 17d is positioned closer to the support ring 14 as compared with the corner portion 17d shown in FIG. 2, the support ring 14 comes to contact with the contacting surface 17b at the position away from the corner portion 17d. In other words, the corner portion 17d does not come to contact with the support ring 14.

Although the illustration is omitted, in a case in which the contacting surface 17b is larger in the axial direction and smaller in the radial direction as compared with the desired size, the corner portion 17d of the holding member 17 is positioned away from the support ring 14 as compared with the corner portion 17d shown in FIG. 2. The support ring 14 comes to contact with the contacting surface 17b at the position away from the corner portion 17d, and the corner portion 17d does not come to contact with the support ring 14.

As described above, in the shock absorber 100, because the contacting surface 17b is, as a whole, inclined with respect to the opposing surface 17a, even in a case in which the contacting surface 17b is formed to have a size different from the desired size, the corner portion 17d does not come to contact with the support ring 14.

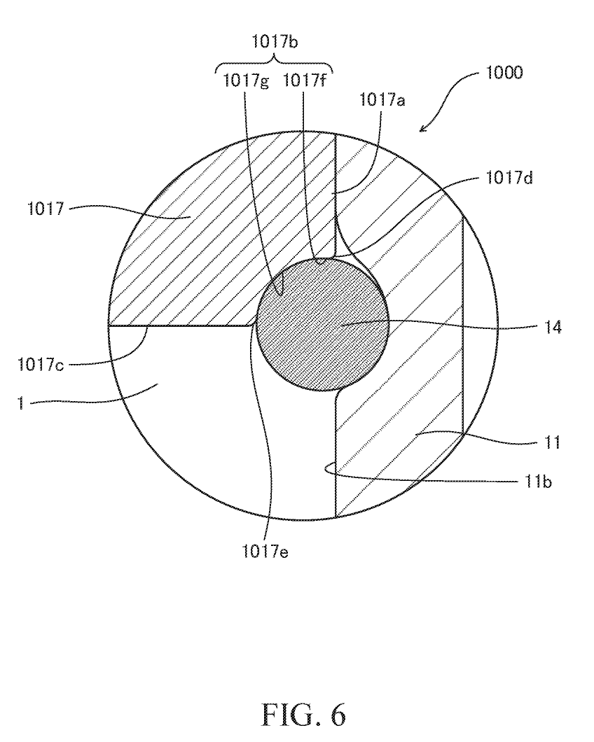

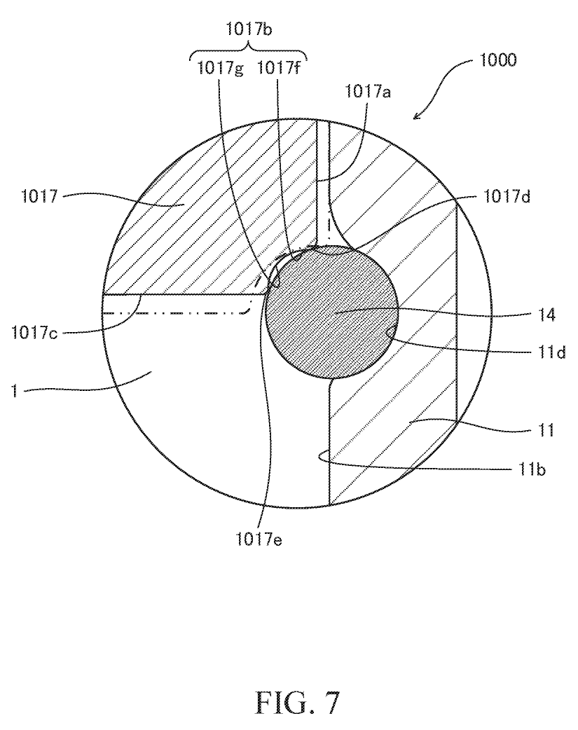

For ease of understanding of the shock absorber 100, a shock absorber 1000 of a comparative example will be described with reference to FIGS. 6 and 7.

FIG. 6 is an enlarged sectional view of the shock absorber 1000 shown in a manner corresponding to FIG. 2. As shown in FIG. 6, a holding member 1017 of the shock absorber 1000 is formed with an opposing surface 1017a, a contacting surface 1017b, and an end surface 1017c. A corner portion 1017d is formed between the opposing surface 1017a and the contacting surface 1017b, and a corner portion 1017e is formed between the end surface 1017c and the contacting surface 1017b. The contacting surface 1017b is formed with a parallel portion 1017f that is in parallel with the direction perpendicular to the opposing surface 1017a (the radial direction) and a curved surface portion 1017g that is concavely curved.

In the holding member 1017 shown in FIG. 6, the contacting surface 1017b is formed to have the desired size. More specifically, the curved surface portion 1017g is formed to have a size that corresponds to a cross sectional contour of the support ring 14, and the entire surface of the curved surface portion 1017g comes contact with the support ring 14. The corner portion 1017d is formed between the parallel portion 1017f and the opposing surface 1017a and is positioned in the vicinity of the support ring 14.

FIG. 7 is an enlarged sectional view of the holding member 1017 having the contacting surface 1017b smaller than the desired size and is shown in a manner corresponding to FIG. 6. As shown in FIG. 7, when the contacting surface 1017b is smaller than the desired size, there may be a case in which the contacting surface 1017b does not come to contact with the support ring 14. In this case, the support ring 14 comes off from the parallel portion 1017f and comes to contact with the corner portion 1017d.

In addition, when a gap between the cylinder tube 11 and the holding member 1017 is large, there may be a case in which the contacting surface 1017b does not come to contact with the support ring 14. Also in this case, similarly to the case described above, the support ring 14 comes off from the parallel portion 1017f and comes to contact with the corner portion 1017d.

As described above, in the shock absorber 1000, the contacting surface 1017b is formed with the parallel portion 1017f. Thus, when the contacting surface 1017b is not formed to have the desired size, the corner portion 1017d comes to contact with the support ring 14. When the holding member 1017 is pushed against the support ring 14 in a state in which the corner portion 1017d is in contact with the support ring 14, a high stress is produced in the corner portion 1017d. There is a risk that this stress causes the deformation of the holding member 1017 and causes deterioration of the durability of the shock absorber 1000. In order to prevent the deterioration of the durability of the shock absorber 1000, a strict management of dimensional errors of the contacting surface 1017b is required. As a result, the shock absorber 1000 cannot be produced with ease, and a production cost is increased.

In contrast, as shown in FIG. 2, in the shock absorber 100, the contacting surface 17b is, as a whole, inclined with respect to the opposing surface 17a. In a case in which the contacting surface 17b is formed to have the desired size, the support ring 14 comes to contact with the contacting surface 17b at the position away from the corner portion 17d, and a predetermined gap is formed between the corner portion 17d and the support ring 14.

Even in a case in which the forming accuracy of the contacting surface 17b is low and the contacting surface 17b is not formed to have the desired size, the corner portion 17d does not come to contact with the support ring 14, and the contacting surface 17b comes to contact with the support ring 14. Therefore, even if the management of the dimensional errors of the contacting surface 17b is not performed strictly, it is possible to prevent contact between the corner portion 17d and the support ring 14.

Because the management of the dimensional errors of the contacting surface 17b needs not be performed strictly, the production of the shock absorber 100 becomes easy. Because the contact between the corner portion 17d and the support ring 14 can be prevented, it is possible to prevent a high stress from being produced in the holding member 17, and it is possible to prevent the deformation of the holding member 17. Therefore, it is possible to improve the durability of the shock absorber 100.

As shown in FIG. 2, in the shock absorber 100, the contacting surface 17b is formed so as to have a straight line shape. Thus, the contacting surface 17b can be formed without requiring a complex processing. It is possible to form the holding member 17 with ease, and it is possible to produce the shock absorber 100 with ease.

The support ring 14 is formed so as to have an annular cross section. A gap G between a circumference edge 11e of the groove 11d on the opposite side from the opening 11a of the cylinder tube 11 (see FIG. 1) and the contacting surface 17b of the holding member 17 is smaller than a diameter D of the cross section of the support ring 14. Thus, the support ring 14 is less likely to slip off from the groove 11d through a gap between an edge of the groove 11d and the contacting surface 17b of the holding member 17. Therefore, it is possible to prevent a damage of the shock absorber 100 caused by the slippage of the support ring 14 from the groove 11d.

As shown in FIGS. 1 and 2, in the shock absorber 100, the bearing member 15, the seal member 16, and the holding member 17 are formed as separate components, and they are assembled to each other to form the guide portion 12. The guide portion 12 may be formed integrally as a single part. In this case, a part serving as the guide portion 12 has a function of supporting the rod 30 and a function of closing the opening 11a of the cylinder tube 11, and this part is formed with the opposing surface 17a and the contacting surface 17b.

The guide portion 12 may not be provided with the holding member 17, and the bearing member 15 may be formed with the opposing surface 17a and the contacting surface 17b. The outer diameter of the holding member 17 may be smaller than the inner diameter of the support ring 14, and the bearing member 15 may be formed with the opposing surface 17a and the contacting surface 17b.

In the shock absorber 100, the bearing member 15, the seal member 16, and the holding member 17 are formed as separate components, and the opposing surface 17a and the contacting surface 17b are formed to the holding member 17 that is a separate component from the bearing member 15 and the seal member 16. Because the bearing member 15 and the seal member 16 need not be formed with the opposing surface 17a and the contacting surface 17b, it is possible to improve the durability of the shock absorber 100 while ensuring that the guide portion 12 has the function of supporting the rod 30 and the function of closing the opening 11a.

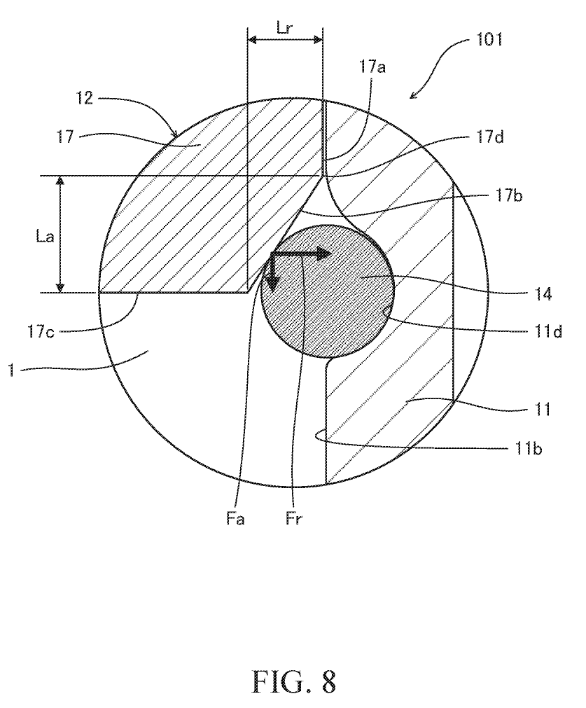

FIG. 8 is an enlarged sectional view of a shock absorber 101 of a modification of the first embodiment shown in a manner corresponding to FIG. 2. In the shock absorber 101, the contacting surface 17b has a shape that is longer in the axial direction than in the radial direction. More specifically, the longitudinal length La of the contacting surface 17b is longer than the lateral length Lr of the contacting surface 17b.

When the holding member 17 is pushed against the support ring 14, the support ring 14 is subjected to a force Fa exerted in the axial direction and a force Fr exerted outward in the radial direction by the holding member 17. Because the longitudinal length La of the contacting surface 17b is longer than the lateral length Lr of the contacting surface 17b, the force Fr exerted outwards in the radial direction is greater than the force Fa exerted in the axial direction, and so, the support ring 14 is pushed against the cylinder tube 11 with a greater force. Therefore, the support ring 14 is less likely to come off from the groove 11d, and it is possible to prevent the damage of the shock absorber 101.

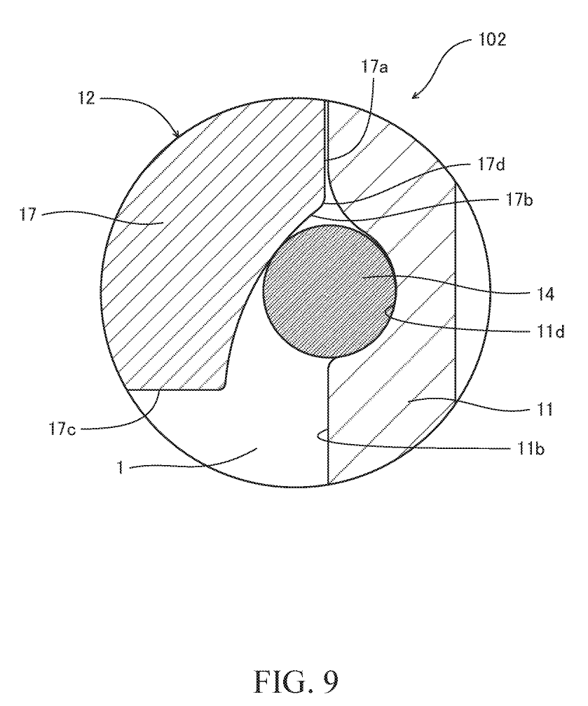

FIG. 9 is an enlarged sectional view of a shock absorber 102 of a modification of the first embodiment shown in a manner corresponding to FIG. 2. In the shock absorber 102, the contacting surface 17b of the holding member 17 is formed so as to be concavely curved. Thus, a contact area between the contacting surface 17b and the support ring 14 is increased. Therefore, it is possible to reduce the stress produced in the holding member 17 when the holding member 17 is pushed against the support ring 14, and it is possible to improve the durability of the shock absorber 102.

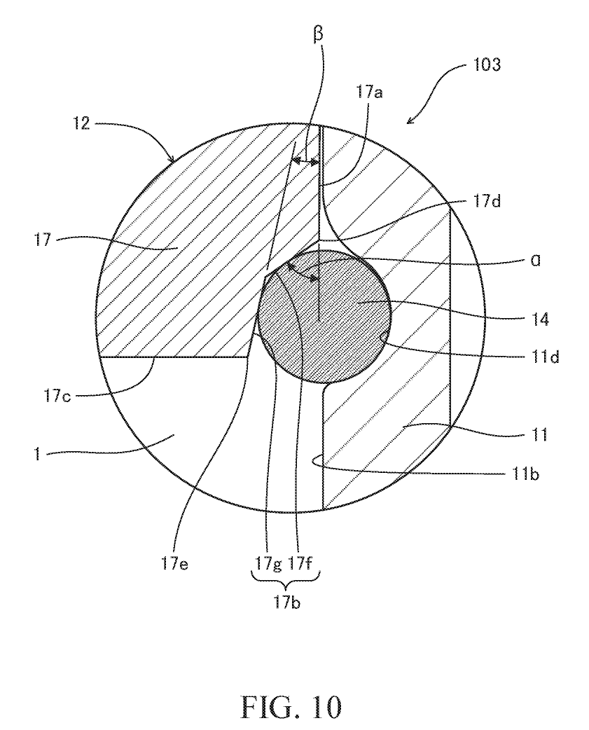

FIG. 10 is an enlarged sectional view of a shock absorber 103 of a modification of the first embodiment shown in a manner corresponding to FIG. 2. In the shock absorber 103, two tapered portions are formed in the contacting surface 17b of the holding member 17. More specifically, the contacting surface 17b is formed with a first tapered portion 17f and a second tapered portion 17g. The first tapered portion 17f is inclined with respect to the opposing surface 17a at a first angle α, and the second tapered portion 17g is inclined with respect to the opposing surface 17a at a second angle β that is smaller than the first angle α. The first tapered portion 17f is formed continuously from the corner portion 17d, and the second tapered portion 17g is formed continuously from the first tapered portion 17f so as to be connected to the corner portion 17e.

Also with the shock absorber 103, even if the management of the dimensional errors of the contacting surface 17b is not performed strictly, it is possible to prevent the contact between the corner portion 17d and the support ring 14. Therefore, it is possible to improve the durability of the shock absorber 103, and the production of the shock absorber 103 becomes easy.

### Second Embodiment

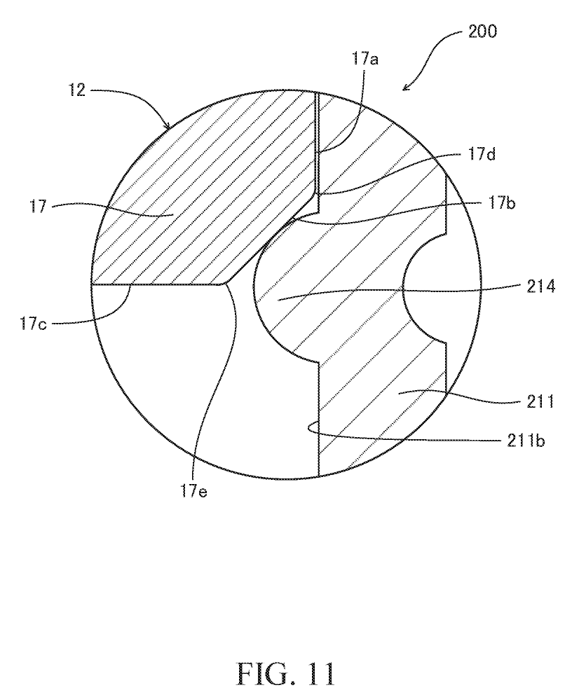

Next, a shock absorber 200 of a second embodiment according to the present invention will be described with reference to FIG. 11. Components that are the same as those in the first embodiment are assigned the same reference numerals and descriptions thereof will be omitted. In addition, because a sectional view of the shock absorber 200 is substantially the same as the sectional view of the shock absorber 100 shown in FIG. 1, illustration thereof will be omitted.

FIG. 11 is an enlarged sectional view of the shock absorber 200 shown in a manner corresponding to FIG. 2. The shock absorber 200 is provided with a substantially cylindrical cylinder tube 211, the annular guide portion 12, and an annular support projection (support portion) 214 that supports the guide portion 12.

The support projection 214 is formed so as to be projected from an inner circumferential surface 211b of the cylinder tube 211 by roll crimping a part of the cylindrical cylinder tube 211. In other words, the support projection 214 is formed integrally with the cylinder tube 211. The support projection 214 is formed so as to have a semi-circular cross section.

The support projection 214 may be formed over the entire circumference of the inner circumference of the cylinder tube 211, or the support projection 214 may be formed only at a part of the inner circumference of the cylinder tube 211.

Also in the shock absorber 200, the contacting surface 17b of the holding member 17 is, as a whole, inclined with respect to the opposing surface 17a. Thus, the support projection 214 comes to contact with the contacting surface 17b at the position away from the corner portion 17d, and a predetermined gap is formed between the corner portion 17d and the support projection 214. Even in a case in which the forming accuracy of the contacting surface 17b is low and the contacting surface 17b is not formed to have the desired size, the corner portion 17d is less likely to come to contact with the support projection 214, and the contacting surface 17b comes to contact with the support projection 214. Therefore, even if the management of the dimensional errors of the contacting surface 17b is not performed strictly, it is possible to prevent contact between the corner portion 17d and the support projection 214.

Because the management of the dimensional errors the contacting surface 17b needs not be performed strictly, the production of the shock absorber 200 becomes easy. Because the contact between the corner portion 17d and the support projection 214 can be prevented, it is possible to prevent a high stress from being produced in the holding member 17, and it is possible to prevent the deformation of the holding member 17. Therefore, it is possible to improve the durability of the shock absorber 200.

With the shock absorber 200, because the support projection 214 is formed integrally with the cylinder tube 211, the support projection 214 does not fall off from the cylinder tube 211 even when the force is exerted by the holding member 17. Therefore, it is possible to prevent the damage of the shock absorber 200.

The contacting surface 17b of the holding member 17 may be formed so as to be concavely curved. In this case, similarly to the shock absorber 102 (see FIG. 9), the contact area between the contacting surface 17b and the support projection 214 is increased. Therefore, even when the holding member 17 is pushed against the support projection 214, it is possible to reduce the stress produced in the holding member 17, and it is possible to improve the durability of the shock absorber 200.

The configurations, operations, and effects of the embodiment according to the present invention will be collectively described below.

In this embodiment, the shock absorber (100, 101, 102, 103, 200) includes: the cylinder tube (11, 211); the damping-force generating portion 20 freely movably accommodated in the cylinder tube (11, 211), the damping-force generating portion 20 being configured to generate damping force by moving in the cylinder tube (11, 211); the rod 30 linked to the damping-force generating portion 20, the rod 30 extending from the opening 11a of the cylinder tube (11, 211); the annular guide portion 12 provided in the inner circumference of the cylinder tube (11, 211), the annular guide portion 12 being configured to guide movement of the rod 30; and the annular support ring 14 or the annular support projection 214 configured to project from the inner circumferential surface (11b, 211b) of the cylinder tube (11, 211), the support ring 14 or the support projection 214 being configured to support the guide portion 12, wherein the guide portion 12 is formed with: the opposing surface 17a configured to oppose the inner circumferential surface (11b, 211b) of the cylinder tube (11, 211); and the contacting surface 17b in contact with the support ring 14 or the support projection 214, the contacting surface 17b being inclined with respect to the opposing surface 17a, and the contacting surface 17b is formed so as to be, as a whole, inclined with respect to the opposing surface 17a.

With such a configuration, because the contacting surface 17b is, as a whole, inclined with respect to the opposing surface 17a, the support ring 14 or the support projection 214 comes to contact with the contacting surface 17b at the position away from the corner portion 17d between the opposing surface 17a and the contacting surface 17b, and a predetermined gap is formed between the corner portion 17d and the support ring 14 or the support projection 214. Even in a case in which the forming accuracy of the contacting surface 17b is low and the contacting surface 17b is not formed to have the desired size, the corner portion 17d does not come to contact with the support ring 14 or the support projection 214, and the contacting surface 17b comes to contact with the support ring 14 or the support projection 214. Even if the management of the dimensional errors of the contacting surface 17b is not performed strictly, it is possible to prevent the contact between the corner portion 17d and the support ring 14 or the support projection 214. Therefore, it is possible to provide the shock absorber (100, 101, 102, 103, 200) that is capable of improving durability and that is capable of being produced with ease.

In addition, in this embodiment, the contacting surface 17b is formed so as to have a straight line shape.

In this configuration, because the contacting surface 17b is formed so as to have a straight line shape, the contacting surface 17b can be formed without requiring a complex processing. It is possible to form the guide portion 12 with ease, and it is possible to produce the shock absorber (100, 101, 103, 200) with ease.

In addition, in this embodiment, the contacting surface 17b is formed so as to be concavely curved.

With such a configuration, because the contacting surface 17b is formed so as to be concavely curved, the contact area between the contacting surface 17b of the guide portion 12 and the support ring 14 or the support projection 214 is increased. Therefore, it is possible to reduce the stress produced in the guide portion 12 when the guide portion 12 is pushed against the support ring 14 or the support projection 214, and it is possible to improve the durability of the shock absorber 102.

In addition, in this embodiment, the support ring 14 is formed as a separate component from the cylinder tube 11, the inner circumferential surface 11b of the cylinder tube 11 is formed with the annular the groove 11d in which the support ring 14 is arranged, and the contacting surface 17b has the shape that is longer in the axial direction than in the radial direction.

With such a configuration, the contacting surface 17b has the shape that is longer in the axial direction than in the radial direction. When the guide portion 12 is pushed against the support ring 14, the support ring 14 receives greater force in the radial direction than in the axial direction from the guide portion 12. Therefore, the support ring 14 is less likely to come off from the groove 11d, and it is possible to prevent the damage of the shock absorber (101, 102, 103).

In addition, in this embodiment, the support ring 14 is formed so as to have a semi-circular cross section, and a gap between the circumference edge 11e of the groove 11d on the opposite side from the opening 11a of the cylinder tube 11 and the contacting surface 17b of the guide portion 12 is smaller than the diameter of the cross section of the support ring 14.

With such a configuration, because the gap between the circumference edge 11e of the groove 11d and the contacting surface 17b of the guide portion 12 is smaller than the diameter of the cross section of the support ring 14, the support ring 14 is prevented from slipping off from the groove 11d through this gap. Therefore, the support ring 14 is less likely to come off from the groove 11d, and it is possible to prevent the damage of the shock absorber (100, 101, 102, 103, 200).

In addition, in this embodiment, the guide portion 12 is provided with the bearing member 15 configured to slidably support the rod 30; the seal member 16 arranged between the bearing member 15 and the opening 11a of the cylinder tube (11, 211), the seal member 16 being configured to close the opening 11a; and the holding member 17 arranged between the bearing member 15 and the support ring 14 or the support projection 214, the holding member 17 being configured to hold the bearing member 15 and the seal member 16, and wherein the opposing surface 17a and the contacting surface 17b are formed in the holding member 17.

With such a configuration, the opposing surface 17a and the contacting surface 17b are formed to the holding member 17 that is a separate component from the bearing member 15 and the seal member 16. Because the bearing member 15 and the seal member 16 need not be formed with the opposing surface 17a and the contacting surface 17b, it is possible to improve the durability of the shock absorber (100, 101, 102, 103, 200) while ensuring that the guide portion 12 has the function of supporting the rod 30 and the function of closing the opening 11a of the cylinder tube (11, 211).

Although the embodiment of the present invention has been described above, the above embodiment is merely an illustration of one exemplary application of the present invention and is not intended to limit the technical scope of the present invention to the specific configuration of the above embodiment.

(1) In the above-mentioned embodiments, descriptions have been given of the shock absorber (100, 101, 102, 103, 200) that is also referred to as a single-cylinder-type shock absorber. The present invention may be applied to a so-called multi-cylinder-type shock absorber that includes an outer cylinder that is arranged on the outer side of the cylinder 10 and the reservoir that is formed between the cylinder 10 and the outer cylinder.

The present application claims a priority based on Japanese Patent Application No. 2016-185800 filed with the Japan Patent Office on Sep. 23, 2016, and all the contents of this application are incorporated herein by reference.

1. A shock absorber comprising:
a cylinder tube;
a damping-force generating portion freely movably accommodated in the cylinder tube, the damping-force generating portion being configured to generate damping force by moving in the cylinder tube;
a rod linked to the damping-force generating portion, the rod extending from an opening of the cylinder tube;
an annular guide portion provided in an inner circumference of the cylinder tube, the guide portion being configured to guide movement of the rod; and
an annular support portion provided to project from an inner circumferential surface of the cylinder tube, the support portion being configured to support the guide portion, wherein
the guide portion has an opposing surface formed to oppose the inner circumferential surface of the cylinder tube, and a contacting surface in contact with the support portion, the contacting surface being inclined with respect to the opposing surface, and
the contacting surface is formed so as to be, as a whole, inclined with respect to the opposing surface.

2. The shock absorber according to claim 1, wherein
the contacting surface is formed so as to have a straight line shape.

3. The shock absorber according to claim 1, wherein
the contacting surface is formed so as to be concavely curved.

4. The shock absorber according to claim 1, wherein
the support portion is formed as a separate component from the cylinder tube,
the inner circumferential surface of the cylinder tube is formed with an annular groove in which the support portion is arranged, and
the contacting surface has a shape that is longer in an axial direction than in a radial direction.

5. The shock absorber according to claim 4, wherein
the support portion is formed so as to have a semi-circular cross section, and
a gap between a circumference edge of the groove on an opposite side from an opening of the cylinder tube and the contacting surface of the guide portion is smaller than a diameter of the cross section of the support portion.

6. The shock absorber according to claim 1, wherein
the guide portion is provided with:
a bearing member configured to slidably support the rod;
a seal member arranged between the bearing member and the opening of the cylinder tube, the seal member being configured to close the opening; and
a holding member arranged between the bearing member and the support portion, the holding member being configured to hold the bearing member and the seal member, and wherein
the opposing surface and the contacting surface are formed in the holding member.
